(19) United States
(12) Patent Application Publication
(10) Pub. No.: US 2012/0263548 A1
(43) Pub. Date: Oct. 18, 2012

(54) DRILL BIT

(76) Inventor: Richard Paul Harris, Levittown, NY (US)

(21) Appl. No.: 13/445,880

(22) Filed: Apr. 12, 2012

Related U.S. Application Data
(60) Provisional application No. 61/474,469, filed on Apr. 12, 2011.

(51) Int. Cl. B23B 51/02

(52) U.S. Cl. 408/224

(57) ABSTRACT

A drill bit drills through porcelain and other hard tiles much more efficiently than conventional drill bits. The porcelain and hard tile drill bit includes a four-point tip angle on the tip so the drill bit starts up correctly and does not run on initial startup of drilling. Through its step angle design and specially designed carbide tip, the drill bit realizes a very fast drill rate and longer drill bit life. Conventional drill bits have no step angle, only a rounded standard carbide tip with no four-point tip angle for easy start-up. The present drill bit solves the start-up problem and through the step angle, allows a sharper and much longer drill life, permitting the drilling of many holes through porcelain and hard tile.

### CROSS-REFERENCE TO RELATED APPLICATIONS

This application claims the benefit of priority of U.S. provisional patent application number 61/474,469, filed Apr. 12, 2011, the contents of which are herein incorporated by reference.

### BACKGROUND OF THE INVENTION

The present invention relates to drill bits and, more particularly, to a drill bit that drills through porcelain and other hard tiles much more efficiently than conventional drill bits.

Conventional glass spearpoint drill bits have been used on hard tile installations for many years. It does not have the proper carbide tip nor does it have the proper tip angles for cutting through hard tile. Because of the rounded tip design and inferior carbide classification, the glass bit is very difficult to start-up. Moreover, this conventional bit does not have a sharp and precise drilling action drilling very slowly dulling out the drill tip very quickly.

As can be seen, there is a need for an improved drill bit for drilling through porcelain and other hard tiles.

### SUMMARY OF THE INVENTION

In one aspect of the present invention, a drill bit comprises a shank; a drill bit point tip connected at one end of the shank, wherein a drill point at an end of the drill point tip; a first step angle formed along a cutting edge of the drill bit point tip, the first step angle formed between the drill point and the shank; and a second step angle formed along the cutting edge of the drill bit point tip, the second step angle formed between the first step angle and the shank.

In another aspect of the present invention, a drill bit comprises a shank; drill bit point tip connected at one end of the shank, wherein a drill point at an end of the drill point tip; a first step angle formed along a cutting edge of the drill bit point tip, the first step angle formed between the drill point and the shank; a second step angle formed along the cutting edge of the drill bit point tip, the second step angle formed between the first step angle and the shank; and a four-point cutting angle formed in the drill point, wherein the first step angle is from about 154 degrees to about 164 degrees; and the second step angle is from about 161 degrees to about 171 degrees.

These and other features, aspects and advantages of the present invention will become better understood with reference to the following drawings, description and claims.

### BRIEF DESCRIPTION OF THE DRAWINGS

FIG. 1 is a side view of a drill bit point tip according to an exemplary embodiment of the present invention;

FIG. 2 is a side view of a shank used on the drill point tip of FIG. 1;

FIG. 3 is a side view of the shank of FIG. 2 connected to the drill bit point tip of FIG. 1 to provide a drill bit according to an exemplary embodiment of the present invention;

FIG. 4 is a pictorial representation of the drill bit of FIG. 3 being used to drill a porcelain surface; and

FIG. 5 is a detailed end view of the drill bit of FIG. 3

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a drill bit that drills through porcelain and other hard tiles much more efficiently than conventional drill bits. The porcelain and hard tile drill bit includes a four-point tip angle on the tip so the drill bit starts up correctly and does not run on initial startup of drilling. Through its step angle design and specially designed carbide tip, the drill bit realizes a very fast drill rate and longer drill bit life. Conventional drill bits have no step angle, only a rounded standard carbide tip with no four-point tip angle for easy start-up. The present drill bit solves the start-up problem and through the step angle, allows a sharper and much longer drill life, permitting the drilling of many holes through porcelain and hard tile.

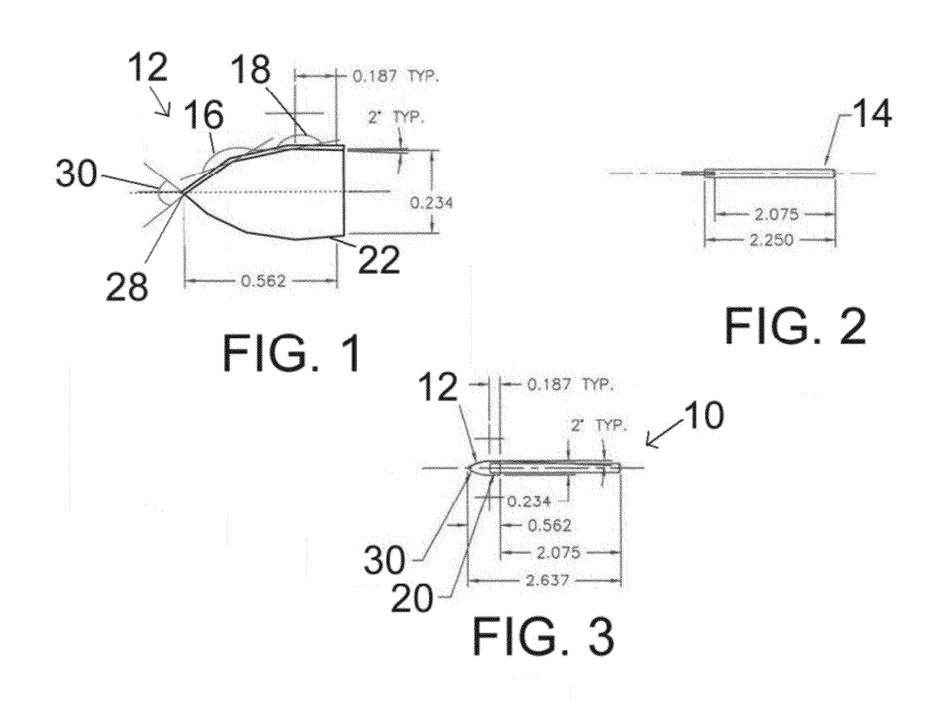

Referring to FIGS. 1 through 3, a drill bit 10 may include a drill bit point tip 12 attached to a shank 14. The drill bit point tip 12 may be a carbide drill bit point tip, for example, K10 carbide. The shank 14 may be a centerless, ground and polished, hardened steel shank hardened to hrc43-45, for example. The drill bit point tip 12 may be connected to the shank 14 by, for example, a braze joint 20, making it a single working piece.

The drill point tip 12 may include a drill point 28 at the end thereof. The drill point may be formed generally in a point having an angle 30 from about 60 to about 80 degrees, typically about 70 degrees.

The drill bit point tip 12 may include two or more step angles, including at least a first step angle 16 and a second step angle 18. The number of step angles may depend on the size (diameter) of the drill bit. The larger the drill bit, the greater number of step angles. For example, a ¼ inch or a ⅜ inch diameter drill bit may have two step angles. In this case, the first step angle 16 may be from about 149 to about 169 degrees, typically from about 154 to about 164 degrees, typically about 159 degrees. The second step angle 18 may be from about 156 to about 176 degrees, typically from about 161 to about 171 degrees, typically about 166 degrees.

Sides 22 of the drill bit point tip 12 between the second (or last) step angle 18 and the braze joint 20, may be angled inward toward a centerline 24 of the drill bit point tip 12. In some embodiments, these sides 22 may be angled about 2 degrees inward, as shown in FIG. 1.

The steel shank 14 on the drill bit 10 may be round and, depending on the size of the drill bit, a certain length. The shank goes into a mechanical drill holder (not shown) which tightens up around the shank 14 of the drill bit 10, securing the drill bit 10 for a proper drilling process. The speed of the drill may be adjusted for suitable drilling speed, which is typically from about 1000 to about 1200 rpm.

As shown in FIG. 5, the drill bit point tip 12 includes a four-point cutting angle 26 on the end thereof. The cutting angle 26 is designed to start the drilling process without the drill bit 10 running off the desired drilling hole.

The drill bit 10 may be used in drilling glass, stone, marble, granite, plastic, porcelain, ceramic tiles, mirrors, and the like.

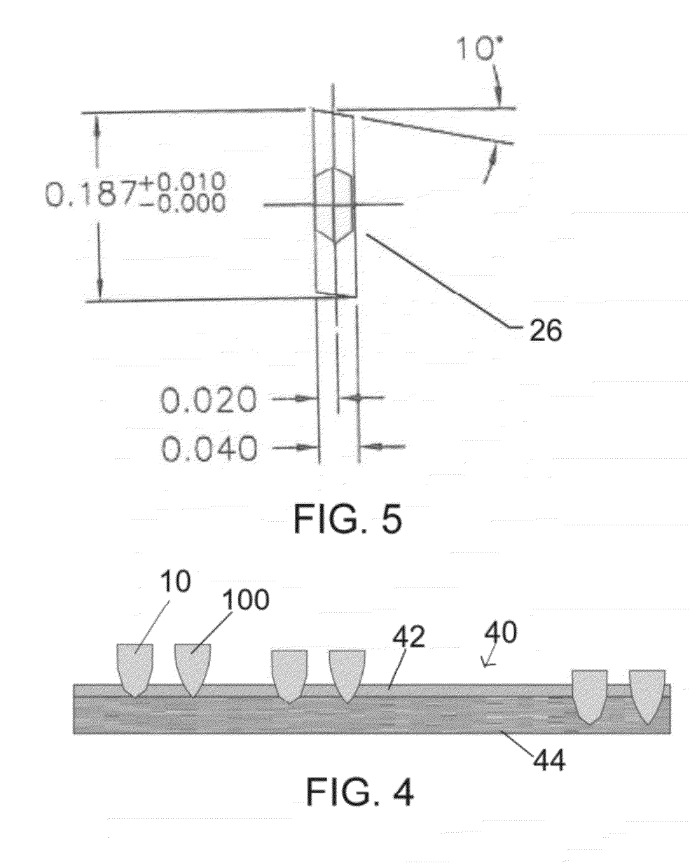

As shown in FIG. 4, a porcelain material 40 may include a hard glaze layer 42 and a compact porcelain 44. FIG. 4 shows a conventional bit 100 and the drill bit 10 of the present invention. In the first set of bits, the first angle on the drill bit point top 12 may drill through the hard glaze layer 42 in a step-wise manner rather than a continuous manner as with the conventional bit 100. The step angle design of the drill bit 10 of the present invention protects the backside cutting edges of the bit and the bit 10 wears out at a much slower rate than the conventional bit 100. The drill bit 10 takes three to four steps to finish the diameter under the pointed thickness drilling. The whole bit 10 is stepping into the hard porcelain in 3-4 steps which can reduce the carbide damage in the drilling process and prolong the bit's drilling life and sharpness. With the conventional bit 100, the either cutting edge is continuously cutting the entire diameter, rather than a step-wise process as with the present invention.

It should be understood, of course, that the foregoing relates to exemplary embodiments of the invention and that modifications may be made without departing from the spirit and scope of the invention as set forth in the following claims.

What is claimed is:

1. A drill bit comprising:
a shank;
a drill bit point tip connected at one end of the shank, wherein a drill point at an end of the drill point tip;
a first step angle formed along a cutting edge of the drill bit point tip, the first step angle formed between the drill point and the shank; and
a second step angle formed along the cutting edge of the drill bit point tip, the second step angle formed between the first step angle and the shank.

2. The drill bit of claim 1, further comprising a four-point cutting angle formed in the drill point.

3. The drill bit of claim 1, wherein the first step angle is from about 149 degrees to about 169 degrees.

4. The drill bit of claim 1, wherein the first step angle is about 159 degrees.

5. The drill bit of claim 1, wherein the second step angle is from about 156 degrees to about 176 degrees.

6. The drill bit of claim 1, wherein the second step angle is about 166 degrees.

7. The drill bit of claim 1, wherein a side portion of the drill bit, between the second step angle and the shank, angles inward toward a centerline of the drill bit at an angle of about 2 degrees.

8. A drill bit comprising:
a shank;
a drill bit point tip connected at one end of the shank, wherein a drill point at an end of the drill point tip;
a first step angle formed along a cutting edge of the drill bit point tip, the first step angle formed between the drill point and the shank;
a second step angle formed along the cutting edge of the drill bit point tip, the second step angle formed between the first step angle and the shank; and
a four-point cutting angle formed in the drill point, wherein the first step angle is from about 154 degrees to about 164 degrees; and
the second step angle is from about 161 degrees to about 171 degrees.

9. The drill bit of claim 8, wherein:
the first step angle is about 159 degrees; and
the second step angle is about 166 degrees.

10. The drill bit of claim 8, wherein a side portion of the drill bit, between the second step angle and the shank, angles inward toward a centerline of the drill bit at an angle of about 2 degrees.
